(19) United States
(12) Patent Application Publication
(10) Pub. No.: US 2015/0095350 A1
(43) Pub. Date: Apr. 2, 2015

(54) METHODS, APPARATUSES, AND DEVICES FOR GENERATING MAPS ON A MOBILE DEVICE

(71) Applicant: QUALCOMM Incorporated, San Diego, CA (US)

(72) Inventors: JiaJian Chen, San Jose, CA (US); Hui Chao, San Jose, CA (US); Saumitra Mohan Das, Santa Clara, CA (US)

(73) Assignee: QUALCOMM Incorporated, San Diego, CA (US)

(21) Appl. No.: 14/042,481

(22) Filed: Sep. 30, 2013

(51) Int. Cl. G06F 17/30; G06F 17/27

(52) U.S. Cl. CPC G06F 17/3053; G06F 17/27; G06F 17/30241
USPC 707/749; 707/736; 707/755

(57) ABSTRACT

Methods, apparatuses, and devices for generating maps on a display of, for example, a mobile device, are presented. In one example, a server, such as a map server, may organize a data structure corresponding to a map based, at least in part, on a received query, estimated location, and/or a current route of a mobile device user. Points of interest (POIs) that may be more relevant to a mobile device user may be transmitted from a map server, for example, prior to POIs that may be less relevant. In one example, a plurality of POIs may be rendered on a display of a mobile device. One or more POIs may be emphasized on the display based on one or more criteria.

### BACKGROUND

1. Field

The subject matter disclosed herein relates to mobile electronic devices, and, more particularly, to methods, apparatuses, and articles of manufacture that may be used in association with generating maps on a display of a mobile electronic device.

2. Information

GPS and other like satellite positioning systems (SPSs) have enabled navigation services for mobile handsets in outdoor environments. However, since satellite signals may not be reliably received and/or acquired in an indoor environment, different techniques may be employed to enable indoor navigation services. For example, a mobile device may typically obtain a position fix by measuring ranges to three or more terrestrial wireless access points that may be positioned at known locations. Such ranges may be measured, for example, by obtaining a MAC ID address from signals received from such access points and measuring one or more characteristics of signals received from such access points such as, for example, signal strength, round trip delay, just to name a few examples.

In some implementations, an indoor navigation system may provide a digital electronic map to a mobile device as a mobile device enters a particular indoor area. Such a map may show indoor features such as doors, hallways, entryways, walls, etc. A digital electronic map of an indoor area may also show points of interest (POIs) such as restaurants, cafés, stores, kiosks, restrooms, etc. Such a digital electronic map may be stored at a server to be accessible by a mobile device through selection of a universal resource locator (URL), for example. By obtaining and displaying such a map, a mobile device may indicate its current location, and a location of an associated user, on a display to provide the user with additional context.

However, in some instances, digital electronic maps displayed on a mobile device may occasionally become cluttered with multiple POIs, which may reduce the readability of the mobile device display as well as consume an inordinate amount of time to download from a map server. Under these circumstances, a user may find themselves waiting for a map to load. Further, once loading has completed, the map may be difficult to read, plan routes, and update.

### SUMMARY

Briefly, particular implementations may be directed to a method comprising receiving, from a mobile device, at least one key word, an estimated location of the mobile device, or any combination thereof. The method may also comprise and transmitting descriptors representing POIs to the mobile device, wherein the descriptors are transmitted in a sequence determined, at least in part, by the at least one received key word, by POIs of a related class of the at least one received key word, by the estimated location of the mobile device, or by any combination thereof.

Another particular implementation may be directed to server comprising a transceiver to access a wireless communications channel, and one or more processors coupled to the transceiver to: obtain, from message received at the transceiver, from a mobile device, at least one key word and an estimated location of the mobile device, or any combination thereof; initiate transmission of descriptors through the transceiver, wherein the descriptors represent POIs to the mobile device, the descriptors being transmitted in a sequence determined, at least in part, by the at least one key word, by POIs of a related class of the at least one key word, by the estimated location of the mobile device, or by any combination thereof.

Another particular implementation may be directed to an article comprising a storage medium comprising machine-readable instructions stored thereon which are executable by one or more processors of a server to: obtain, from a message received at a transceiver, from a mobile device, at least one key word, an estimated location of the mobile device, or any combination thereof; and to initiate transmission of descriptors, through the mobile device, representing POIs to the mobile device. In implementations, the descriptors are transmitted in a sequence determined, at least in part, by the at least one key word, by POIs of a related class of the at least one key word, by the estimated location of the mobile device, or by any combination thereof.

Another particular implementation may be directed to an apparatus comprising means for obtaining, from a message received at a transceiver, from a mobile device, at least one key word, an estimated location of the mobile device, or any combination thereof. The apparatus may also comprise means for transmitting descriptors, through the transceiver, representing POIs to the mobile device, the descriptors may be transmitted in a sequence determined, at least in part, by the at least one received key word, by POIs of a related class of the at least one received key word, by the estimated location of the mobile device, or by any combination thereof.

Another particular implementation may be directed to method comprising, at a mobile device, rendering, on a display of the mobile device, a plurality of POIs. The method may also include emphasizing one or more of the plurality of POIs based, at least in part, on one or more criteria comprising at least one of: whether one or more POIs is in a vicinity of an estimated location of the mobile device, whether one or more POIs is on a route being rendered on the mobile device, whether one or more POIs is relevant to a key word submitted in a query by the mobile device, whether one or more POIs is in a complex POI, or on any combination thereof.

Another particular implementation may be directed to a mobile device, comprising: a display to render, a plurality of POIs; and one or more processors coupled to the display to: emphasize one or more of the plurality of POIs based, at least in part, on one or more criteria comprising at least one of: one or more POIs being in a vicinity of an estimated location of the mobile device, one or more POIs being on a route rendered on the display, one or more POIs being relevant to a key word submitted in a query by the mobile device, one or more POIs being in a complex POI, or on any combination thereof.

Another particular implementation may be directed to an article comprising a storage medium comprising machine-readable instructions stored thereon which are executable by one or more processors of a mobile device to: emphasize one or more of a plurality of POIs based, at least in part, on one or more criteria comprising at least one of: one or more POIs being in a vicinity of an estimated location of the mobile device, one or more POIs being on a route rendered on a display, one or more POIs being relevant to a key word submitted in a query by the mobile device, one or more POIs being in a complex POI, or on any combination thereof.

Another particular implementation may be directed to a mobile device, comprising: means for rendering a plurality of POIs; and means for emphasizing one or more of the plurality of POIs based, at least in part, on one or more criteria comprising at least one of: one or more POIs being in a vicinity of an estimated location of the mobile device, one or more POIs being on a route rendered on the mobile device, one or more POIs being relevant to a key word submitted in a query by the mobile device, one or more POIs being in a complex POI, or on any combination thereof.

It should be understood that the aforementioned implementations are merely example implementations, and that claimed subject matter is not necessarily limited to any particular aspect of these example implementations.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic diagram of a network topology according to an embodiment.

FIG. 2 is a schematic diagram 20 of a display showing a rendering of an indoor environment in which a method for generating maps may be employed.

FIG. 3 is a schematic diagram of a display showing a rendering of an indoor environment in which a method for generating maps on a display is employed according to an embodiment.

FIG. 4 is a schematic diagram of a display showing a rendering of an indoor environment in which a method for generating maps on a display is employed according to another embodiment.

FIG. 5 is a partial listing of a first data structure and a second, organized data structure that may be used by a mobile device to generate maps on a display according to an embodiment.

FIG. 6 is a flow diagram of a method for generating maps on a display according to an embodiment.

FIG. 7 is a flow diagram of a method for transmitting maps to a mobile device according to an embodiment.

FIGS. 8, 9, and 10 are flow diagrams for methods for generating maps on a display according to embodiments.

FIG. 11 is a schematic block diagram illustrating an exemplary device, in accordance with an implementation.

FIG. 12 is a schematic block diagram of an example computing platform in accordance with an implementation.

### DETAILED DESCRIPTION

In the following detailed description, numerous specific details are set forth to provide a thorough understanding of claimed subject matter. However, those skilled in the art will understand that claimed subject matter may be practiced without these specific details. In other instances, methods, apparatuses, and/or systems that would be known by one of ordinary skill have not been described in detail so as not to obscure claimed subject matter.

As used herein, “mobile electronic device,” “mobile device,” “wireless device,” or the plural form of such terms may be used interchangeably and may refer to any kind of special purpose computing platform or apparatus that may from time to time occupy a position that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be referred to simply as “mobile devices,” may include, for example, cellular telephones, smart telephones, personal digital assistants, laptop computers, personal entertainment systems, tablet personal computers, personal audio or video devices, personal navigation devices, or the like. It should be appreciated, however, that these are merely examples of mobile devices that may be used, at least in part, to implement one or more operations and/or techniques for displaying digital maps, such as digital maps of an indoor area, on a mobile device, for example, and that claimed subject matter is not limited in this respect. It should also be noted that the terms “position” and “location” may be used interchangeably herein.

In implementations, a mobile communications device may estimate its current location by way of an indoor navigation approach. Such approaches may involve obtaining a range from one or more wireless access points, for example, by way of receiving a Media Access Control (MAC) address from signals transmitted from access points and/or by measuring one or more characteristics of received signals. In certain implementations, signals received from such access points may be analyzed by a mobile device to estimate its location based on received signal strength, round trip delay to and from a wireless access point, and so forth. In certain implementations, measured signal strength and/or round trip delay may be combined with an indoor “heat map” signature to relate one or more received signal strength measurements with approximate distances from wireless access points. It should be noted, however, that various approaches may be employed to estimate a current location of a mobile device, and claimed subject matter is not limited in this respect.

As used herein, the term “point of interest” or “POI” may refer to a specific useful or interesting point location on a digital map or other type of diagrammatic representation of an area showing physical features. Thus, POIs may include bathrooms, conference and/or meeting rooms, department stores, boutiques, kiosks, elevators, escalators, staircases, restaurants, or the like, which may be overlaid on a digital map of a shopping mall, stadium, town square, amphitheater, parking garage, amusement park, or other area. An electronic digital map may, for example, be stored at a suitable server, such as a map server and may be wirelessly accessible by a mobile device, such as via a selection of a Uniform Resource Locator (URL), for example. By obtaining a digital map of an indoor or like area of interest, a mobile device may, for example, be capable of overlaying its current location on the displayed map of the area so as to provide a user with additional context, frame of reference, or the like.

Also as used herein, the term “descriptor” may comprise an element that may be used by a mobile device to describe, for example or represent, a POI on a digital map. In this context, a descriptor may comprise one or more absolute and/or relative location coordinates in an X, Y, Z coordinate system (e.g., Cartesian coordinate system) for example. Descriptors may characterize or represent geometrical components, such as walls, room dividers, staircases, elevator shafts, and so forth. A descriptor may comprise one or more components for representing or characterizing a color, a font, and/or size, of a string of text, for example, of a label that may be used in rendering or depicting a POI on a display of a mobile communications device. A descriptor may also comprise an identifier for a symbol, icon, and/or other type of depiction that may be rendered on a display to designate a POI. In one particular embodiment, a descriptor may encompass a broad category of components and/or elements that may be stored in a memory device accessible to a server, such as a map server, to characterize or represent a POI. One or more descriptors may be transmitted to a mobile device, for example, at which they may be interpreted and/or decoded by a processor of a mobile device. Responsive to interpretation and/or decoding by a processor of one or more descriptors, a POI, and/or any other feature, may be depicted on a display of a mobile communications device, for example. It should be noted, however, that descriptors may be utilized in accordance with other approaches, and claimed such matter is not limited in this respect.

In embodiments, descriptors may be used by a mobile device to depict locations or features that distinguish POIs from one another. In one possible example, one or more descriptors of a POI may represent a label in a local language, such as “Main Entrance,” for example. A descriptor may correspond to a name of an establishment, such as “Le Kids Boutique,” and may comprise a positional component, such as latitude and longitude of an establishment. Descriptors may be utilized by a mobile communications device to render components and/or features of complex POIs, such as buildings, department stores, apartment complexes, and so forth, on a display coupled to a mobile communications device. In one possible example, a descriptor used to describe a complex POI, such as a department store, may be utilized by a mobile device to depict one or more locations within the department store, such as, for example, a sporting goods department, as well as a floor component (e.g., first floor, second floor, third floor). In some embodiments, a POI descriptor may comprise, for example, brands corresponding to products or services offered by a POI. In one possible example, descriptors used to describe a major electronics outlet may include descriptors such as HP, DELL, Apple, etc.

In many instances, a mobile device user may be interested in locating, for example, a particular type of POI within, for example, a large shopping mall. In one possible example, a mobile device user may be interested in locating of one or more food vendors within a shopping mall, outdoor amphitheater, or other relatively large establishment. Thus, if a user has selected to download a digital map of an establishment, which may comprise thousands of descriptors describing hundred POIs, just as an example, a mobile device user may be required to wait patiently while the digital map is downloaded from a server (e.g., a map server) through a wireless access point, for example. In some instances, if a large number of mobile device users, such as concertgoers at an outdoor amphitheater, are engaged in downloading digital maps of the amphitheater, users may be required to wait several minutes, or longer, while wireless access points transmit map data structures corresponding to digital maps to potentially thousands of mobile device users.

At times, a mobile device display may become cluttered with a large number of POIs arranged in close proximity to one another. Thus, mobile device users may experience difficulty in discerning a precise location of particularly interesting POIs relative to other POIs in which the user may have less interest in visiting, for example. In one instance, responsive to a user's search query concerning locations of restaurants in a shopping mall, a user may find that numerous restaurants and other food vendors may be concentrated within a relatively small area of the shopping mall. Further, even while viewing the display at a higher zoom level, the user may find it difficult to distinguish favored restaurants from other eating establishments. This can be especially problematic if a large number POIs are generated and displayed on a display using, for example, a single color, a single font size, etc.

An approach toward rendering POIs on a display may comprise a server, such as a map server, storing descriptors of POIs of an establishment, such as a shopping mall, department store, outdoor amphitheater, etc. In embodiments, in response to receiving a query and/or an estimated location of a mobile device, a map server, for example, may organize one or more stored POI descriptors, based at least in part on an estimated location and/or a key word present in a query transmitted from the mobile device. For example, if a mobile device at a particular estimated location transmits a query comprising, for example, a key word “shoes,” a server, such as a map server, at a shopping mall may organize a data structure to comprise descriptors of relevant POIs within a vicinity of the mobile device. As discussed above, a descriptor of a POI may comprise a text string relevant to the key word “shoes,” for example, and within a particular vicinity of a mobile device, such as 25 meters, just as an example. Responsive to receipt of a query comprising a key word “shoes,” descriptors may be arranged in a first (e.g., upper) portion of a hierarchical data structure and transmitted to the mobile device. Transmission of the first portion of the data structure may be followed by transmission of a remaining (e.g., lower) portion of the organized hierarchical data structure.

Responsive to receipt of at least a first (e.g., upper) portion of an organized hierarchical data structure, a mobile device may generate and render at least a first portion of a digital map on a display. For example, if a mobile device user has submitted a query comprising a key word “shoes,” POIs characterized or represented by a descriptor comprising a label component relevant to “shoes” (such as slippers, boots, sneakers) may be quickly rendered on a display of a mobile device. In some implementations, such display of POIs most relevant to a user query may be displayed immediately after receipt of the first (e.g., upper) portion of organized data structure and regardless of whether an entire organized data structure has been received, for example. This may enable, for example, a mobile device user to determine a location and plan a route to one or more relevant POIs without being required to wait for an entire digital map to download. It should be noted that although particular examples may be used to illustrate various concepts, claimed subject matter is not limited to the above-mentioned examples.

In some implementations, a map server, for example, may organize a data structure such that descriptors for POIs that are more relevant to one or more user-submitted key words may be generated with increased, higher, or greater emphasis compared to less relevant POIs. For example, in particular implementations, representations of one or more POIs in the vicinity of a mobile device user's estimated location may be generated using a first level of detail, such as using all available geometric features (e.g., unabridged geometry). POIs outside of the vicinity of a mobile device user's estimated location may be generated using a second level of detail, such as using fewer than all available geometric features (e.g., abridged geometry). In implementations, de-emphasis of less relevant POIs may permit a user to quickly discern relevant POIs from perhaps less-relevant POIs (e.g., based on a current estimated location and/or one or more key words in a query). In some implementations, depictions of relevant POIs may be generated in a manner that enhances clarity relative to less relevant POIs, such as using a larger font size than a font size used to depict less relevant POIs. In other implementations, portions of a display may emphasize relevant POIs by displaying relevant POIs using increased or higher brightness than is used to display less relevant POIs. However, these represent merely example approaches toward displaying emphasizing relevant POIs and de-emphasizing less relevant POIs, and claimed subject matter is not limited in this respect.

In some implementations, POIs located within a complex POI, such as individual departments within a multilevel department store, outdoor amphitheater, etc., may be generated on a display with emphasis that may be determined or influenced by a relationship between a user's current estimated location and the location of one or more POIs. In one example, if a mobile device user located on the second floor of a multi-level shopping mall submits a query comprising a key word “restaurant,” a server, such as a map server, may organize a data structure so that descriptors representing or characterizing restaurants located on the second floor comprise an initial portion of a data structure to be transmitted to the mobile device. Descriptors representing or characterizing restaurants located at other floors, such as the first floor, third floor, and so forth, may be transmitted after descriptors representing or characterizing restaurants located on the second floor. Additionally, a data structure comprising descriptors representing or characterizing less relevant POIs, such as restaurants located on the first floor, third floor, etc., may be organized into a data structure in a manner that conveys a reduced, lower, or decreased level of detail (e.g., abridged geometry) in relation to descriptors representing or characterizing restaurants located on the second floor, for example.

In implementations, a map server, for example, may organize a data structure for transmission to a mobile device responsive to determining that a key word corresponds to a class of relevant POIs. For example, if a mobile device user submits a query comprising the key words “Q-Mega department store,” a server, such as a map server, may organize a data structure such that descriptors representing or characterizing “Q-Mega” comprise a first (e.g., top) portion of the data structure. In implementations, descriptors representing or characterizing “Q-Mega” may be followed by descriptors representing or characterizing other nearby department stores of a related class, such as “Q-Big Store,” for example. Thus, a mobile device user interested in shopping at Q-Mega may be provided with a detailed map, which may enable a user to locate items in one or more adjacent department stores of a related class without initiating another query, for example.

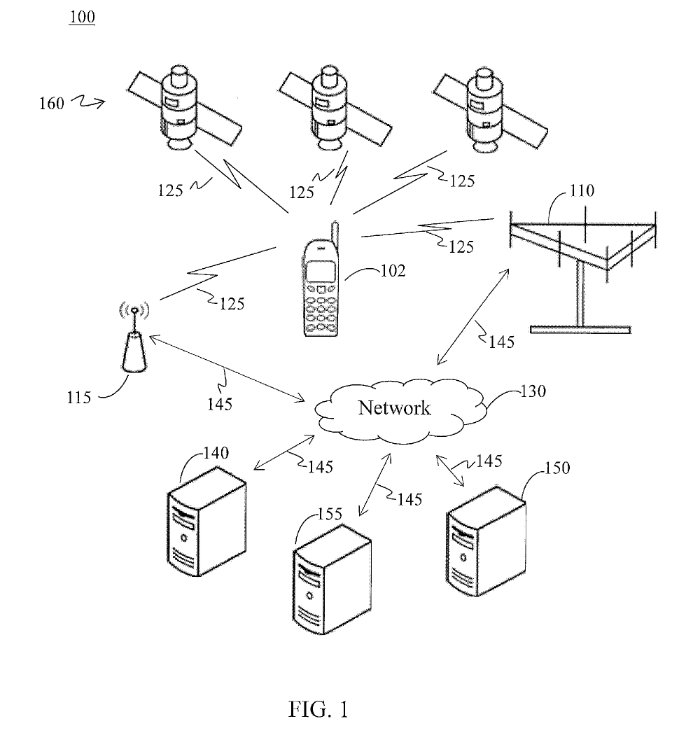

FIG. 1 is a schematic diagram of a network topology 100 according to an embodiment. As described below, one or more processes or operations for generating maps on a display may be implemented in a signal environment that may be utilized by a mobile device 102, for example. It should be appreciated that network topology 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, network topology 100 may comprise, for example, one or more space vehicles 160, base transceiver station 110, wireless transmitter 115, etc. capable of communicating with mobile device 100 via wireless communication links 125 in accordance with one or more protocols. Space vehicles 160 may be associated with one or more satellite positioning systems (SPS), such as, for example, the United States Global Positioning System (GPS), the Russian GLONASS system, the European Galileo system, as well as any system that may utilize space vehicles from any combination of SPSs, or any SPS developed in the future. Space vehicles 160 may also represent one or more orbiting space vehicles of a regional satellite navigation system such as, for example, Quasi-Zenith Satellite System (QZSS) over Japan, Indian Regional Navigational Satellite System (IRNSS) over India, Beidou/Compass over China, etc., and/or various augmentation systems (e.g., an Satellite Based Augmentation System (SBAS)) that may be associated with or otherwise enabled for use with one or more global and/or regional navigation satellite systems. It should be noted that claimed subject matter is not limited to the use of space vehicles such as those space vehicles of the aforementioned global or regional satellite navigation systems. Base transceiver station 110, wireless transmitter 115, etc. may be of the same or similar type, for example, or may represent different types of devices, such as access points, radio beacons, cellular base stations, femtocells, or the like, depending on an implementation. At times, one or more wireless transmitters, such as wireless transmitters 115, for example, may be capable of transmitting as well as receiving wireless signals.

In some instances, one or more base transceiver stations 110, wireless transmitters 115, etc. may, for example, be operatively coupled to a network 130 that may comprise one or more wired or wireless communications or computing networks capable of transmitting messages including items, such as an electronic digital map, via one or more wireless communication links 125, 145, and so forth. As discussed below, items transmitted in messages may include, for example, an electronic digital map (e.g., floor plans, etc.) depicting features of an indoor or like area of interest (e.g., a shopping mall, retailer outlet, etc.) that may be provided to a mobile device by a transmitter, such as one or more of servers 140, 150, and 155, at or upon entering the area. In particular implementations, an electronic digital map may indicate POIs within the area of interest, such as restaurants, cafés, pubs, meeting rooms, restrooms, stores, kiosks, elevators, staircases, escalators, restaurants, and so forth.

Even though a certain number of computing platforms or devices are illustrated herein, any number of suitable computing platforms or devices may be implemented to facilitate or otherwise support one or more techniques or processes associated with network topology 100. For example, at times, network 130 may be coupled to one or more wired or wireless communications networks (e.g., Wi-Fi, etc.) so as to enhance a predominantly indoor coverage area for communications with mobile device 102, one or more base transceiver stations 110, wireless transmitters 115, servers 140, 150, 155, or the like. In some instances, network 130 may facilitate or support femtocell-based operative regions of coverage, for example. Again, these are merely example implementations, and claimed subject matter is not limited in this regard.

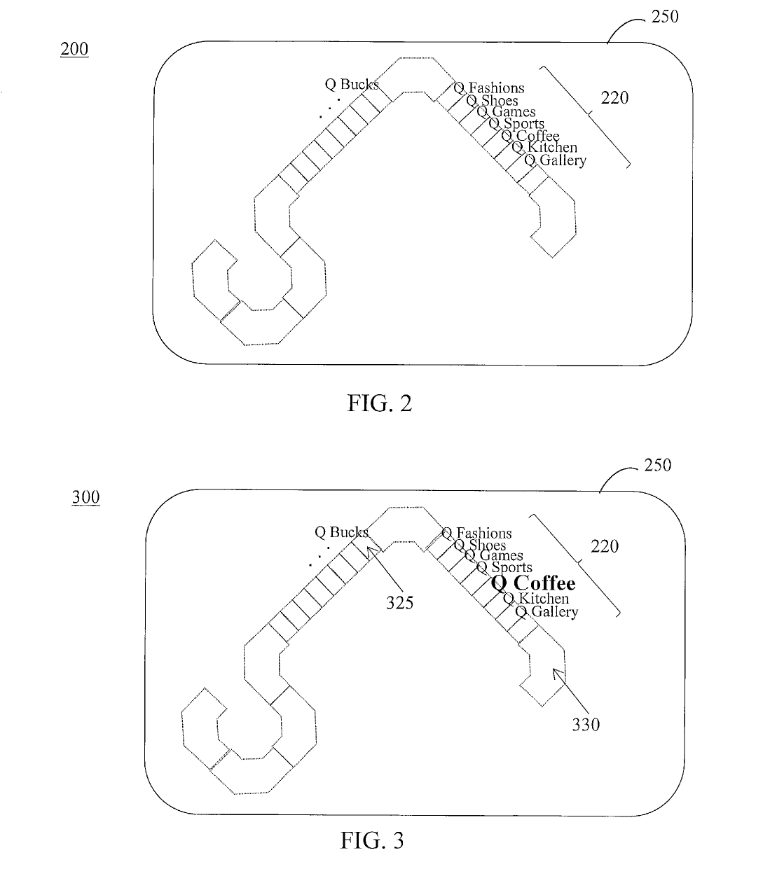

FIG. 2 is a schematic diagram 200 of a display showing a rendering of an indoor environment in which a method for generating maps may be employed. In implementations, generating renderings on display 250 of FIG. 2 may be in response to a server, such as one or more of servers 140, 150, and 155, transmitting a digital map to mobile device 102, for example, by way of wireless network 130 and wireless transmitter 115 of FIG. 1. Responsive to such transmission, mobile device 102 may generate a digital map using display 250. It should be pointed out, however, that display 250 may generate a digital map by way of a wide variety of other means, and claimed subject matter is not limited in this regard.

Display 250 of FIG. 2 may present a rendering of a digital map that represents at least a portion of an indoor shopping mall having a variety of POIs, such as retail stores 220, for example, stored in a data structure of a digital map server. In the embodiment of FIG. 2, it can be seen that various retail establishments are visible on display 250. These include apparel stores (Q Fashion), shoe stores (Q Shoes), game stores (Q Games), sporting goods stores (Q Sports), coffee retailers (Q Coffee, Q Bucks), kitchen stores (Q kitchen), art retailers (Q gallery), and others. In many instances, a user may make use of such a map to navigate through crowded shopping malls, for example, to shop, meet friends, attend venues, and so forth.

However, while attempting to discern finer features of a digital map displayed on display 250, a user may find that doing so may be difficult. For example, if a user is attempting to locate a particular vendor, perhaps at region 220 of FIG. 2, for example, the user may find that identifying the particular vendor within the rendering of the digital map is not an easy task. For example, if region 220 represents a string of boutiques or other specialized retailers at a shopping mall, the user may find that the graphics, geometrical representations of physical features of the shopping mall, and/or other icons may be too closely spaced in the generated depiction to be easily discernible. In such instances, a cluttered rendering may reduce effectiveness of a digital map displayed on a user's mobile device, for example.

FIG. 3 is a schematic diagram 300 of a display showing a rendering of an indoor environment in which a method for generating maps may be employed according to an embodiment. In implementations, display 250 may generate renderings that represent one or more POIs described by descriptors stored in an organized data structure. POIs having greater relevance to at least one key word present in a user-generated query may be indicated or rendered with increased, higher, or greater emphasis than POIs having less relevance. For example, if a user located at an estimated location 330 submits a query comprising the key word “coffee,” the POI “Q Coffee” may be depicted with increased, higher, or greater emphasis compared to less relevant POIs. Clarity enhancing measures may comprise, for example, depiction in of a POI in a different color, a different brightness level, a different font, or using any other distinguishing attribute that emphasizes “Q Coffee” relative to other POIs displayed on display 250. For example, as shown in FIG. 3 the POI “Q Coffee” may be rendered using a larger and different font than other POIs in the vicinity of estimated location 330. Additionally, less-relevant POIs, such as “Q Fashions,” “Q Shoes,” “Q Games,” and so forth, may be rendered using a smaller font, for example, that de-emphasizes the POI with respect to “Q Coffee.” Thus, a user at estimated location 330 may easily identify and locate the retailer “Q Coffee.” It should be pointed out that the retailer “Q Coffee” may be displayed using visually distinguishable features and other clarity enhancing approaches, such as displaying less-relevant POIs with decreased brightness (e.g., dimming), utilizing differently-colored fonts to indicate less relevant POIs, and so forth, and claimed subject matter is not limited in this respect.

In certain embodiments, relevant POIs located outside of a vicinity of a user's estimated location may be de-emphasized in relation to relevant POIs located within the vicinity of an estimated location. For example, in FIG. 3, POI 325, identified as “Q Bucks,” may be located outside of the vicinity of estimated location 330 and be relevant to a key word “coffee” in a manner similar to a descriptor identifying or characterizing the POI “Q Coffee.” However, in FIG. 3 POI 325 may not be emphasized in a manner similar to emphasis of the POI “Q Coffee.” In embodiments, such emphasis on POIs within the vicinity of a mobile device user's estimated location may enable a user to quickly locate a nearby relevant POI (e.g., based on a query) without being distracted by POIs positioned at locations that are relatively remote from a user's current estimated position. In one possible example, POIs located at a distance of less than a certain distance (e.g., 25.0 meters) from a user at a shopping mall may be considered as being within a vicinity of a mobile device user. A POI located at a distance of greater than the certain distance may be considered as being outside of a vicinity of a mobile device user. In another example, a POI located on the same floor as a user may be classified as being in the user's vicinity, while POIs located at different floors or levels may be classified as being outside of the user's vicinity. However, claimed subject matter is intended to embrace any such use of a distance in any direction to designate POIs as lying inside of or outside of a vicinity of a mobile device user.

In particular embodiments, relevant POIs located in a direction that significantly deviates from a user's current route may also be de-emphasized in relation to relevant POIs within the vicinity of an mobile device user's estimated location. Although not shown in FIG. 3, if a user in a shopping mall has recently walked past by a POI relevant to a key word “coffee,” the POI may not be emphasized in response to a user query, for example. In embodiments, de-emphasis of POIs not on a user's route may advantageously preclude or reduce an incidence of a user having to backtrack or to deviate far from an intended route to visit a POI, for example. Thus, a user may remain focused on continuing in a general direction of an intended route, for example. It should be noted, however, that claimed subject matter is not limited in this respect.

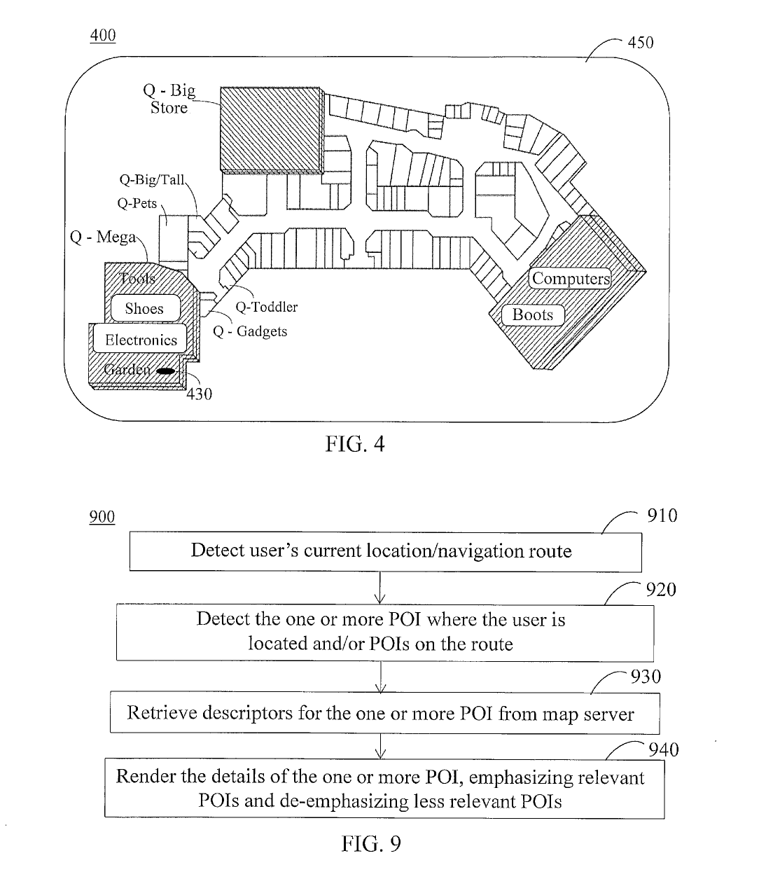

FIG. 4 is a schematic diagram 400 of a display showing a rendering of an indoor environment in which a method for generating maps on a display is employed according to another embodiment. In the embodiment of FIG. 4, display 450 shows a perspective of portions of a shopping mall, for example. Display 450 may render a more relevant complex POI comprising a multilevel structure having at least a first floor and a second floor, for example, and render several POIs having less relevance with respect to a user's query, for example, using a reduced, lower, or decreased degree of detail.

In the example of FIG. 4, a user at an estimated location 430 on a second floor of the “Q-Mega” department store may receive a digital map from a map server, for example, based, at least in part, on the user entering the establishment. An estimated location may be determined by way of one or more approaches previously described herein, such as a mobile device estimating round trip delay from one or more wireless access points, correlation of round-trip delay measurements with heat map signatures, and so forth. In some embodiments, if a user enters a department store (e.g., “Q-Mega”), a server (e.g., a map server) may transmit a digital map of the department store to the user's mobile device. For example, if a mobile device user receives a digital map of a shopping mall, for example, upon entering a complex POI, such as a department store, an additional map that pertains in particular to the complex POI (e.g., the department store “Q-Mega”) may be transmitted to the mobile device. The additional map pertaining to the complex POI may be overlaid on onto a background of the previously received digital map representing the shopping mall, for example. In one possible example, POIs of a shopping mall may be rendered using a first level of detail (e.g., abridged geometry) from POI descriptors received from a first server, such as a map server. Upon entering a complex POI in the shopping mall, such as a department store, a second map server, for example, may transmit POI descriptors representing a second level of detail (e.g., unabridged geometry) for the department store, for example.

In other embodiments, a first portion of a display may depict POIs in response to receiving descriptors from a first server, such as a map server, and a second portion of the display may depict POIs in response to receiving descriptors from a second server. In other instances, a user at an estimated location 430 on a second floor of the department store “Q-Mega” may submit a query that comprises a search term, such as “map” and/or any other type of request for a general layout of a complex POI, such as the “Q-Mega” department store. Responsive to a received query, or responsive to a mobile device user merely entering Q-Mega, a server, such as a map server, (not shown) may organize stored descriptors into a hierarchical data structure based, at least in part, on one or more key words present in a received query and/or an estimated location of a mobile device. A map server, for example, may transmit an organized data structure beginning with POIs having increased, higher, or greater relevance to a user at estimated location 430, such as “shoes” and “electronics,” which may be located in the vicinity of estimated location 430.

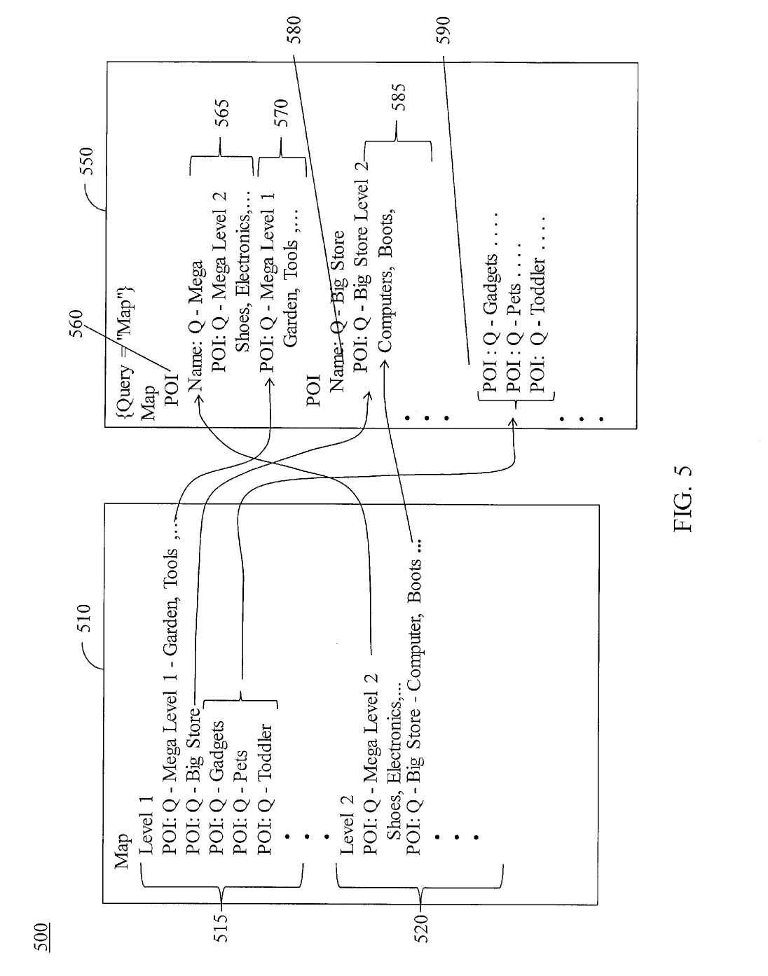

In implementations, such as described in relation to FIG. 5, POI descriptors at or near an upper portion of an organized data structure may be transmitted prior to descriptors arranged near a bottom or lower portion of a hierarchical structure. In implementations, arrangement of relevant POIs, such as POIs most relevant to one or more key words of a user query and/or in the vicinity of a user's estimated location, may be almost immediately rendered on a display. Less relevant POIs, for example, may be rendered on a display at later times, for example. In FIG. 4, areas outside of the vicinity of the user's current estimated location, such as areas located on a different floor than estimated location 430, may be de-emphasized relative to areas located in the vicinity of location 430. For example, a “Garden” department and a “Tools” department located at a first floor of Q-Mega may be, for example, rendered using a dotted font and/or a smaller font in a manner that de-emphasizes its importance to a mobile device user at estimated location 430, or may not be visible at all. Thus, in embodiments, a vicinity may refer to a physical distance (e.g., 25 meters) and/or may refer to ease of access of a mobile device user to a POI. This may permit a mobile device user to focus his or her attention on portions of a complex POI in his or her vicinity, and/or portions of a complex POI more easily accessed from the user's estimated location, without being distracted by portions of a complex POI that may be less accessible. Additionally, if a complex POI, such as the Q-Mega department store comprises dozens, hundreds, thousands, or more distinct areas or other features, receipt of the most relevant features a permit a mobile device to generate at least a portion of a map, such as an indoor map, having significant relevance prior to generating portions of a map having less relevance.

As shown in FIG. 4, the department store “Q -Mega” may be generated on display 450 using a perspective view. Other portions of a shopping mall may be de-emphasized by being rendered as two-dimensional areas using a reduced, lower, or decreased level of detail, such as generating with abridged geometry, for example. Thus, in FIG. 4, less relevant POIs, such as “Q-Pets,” “Q-Big/Tall,” “Q-Toddler,” and “Q-Gadgets” for example, may be rendered using abridged geometry, such as depicting using relatively simple two-dimensional geometrical areas. Further, one or more text strings comprising label descriptors of these POIs may be arranged in a data structure so as to be transmitted from a server, such as a map server, to a mobile device after transmission of more relevant POIs, such as POIs in the vicinity (e.g., POIs having the same floor component) as estimated location 430. Thus, as will be illustrated in the embodiment of FIG. 5, digital map descriptors initially stored in an nonhierarchical data structure may be organized into a hierarchical data structure so that POIs having increased, higher, or greater relevance to a user query are transmitted prior to POIs having reduced, lower, or decreased relevance to a user query. However, again, it should be noted that a variety of mechanisms and approaches may be employed, such as a use of smaller fonts, dotted and/or thinner lines, and so forth, to generate less relevant POIs, and claimed subject matter is not limited in this regard.

In embodiments, such as shown in FIG. 5, a server, such as a map server, may organize a data structure for transmission to a mobile device responsive to determining that a key word may correspond to a class of relevant complex POIs, for example. In one possible example, if a user at estimated location 430 submits a query requesting a layout of the Q-Mega department store, a server, such as a map server, may transmit descriptors representing or characterizing one or more adjacent department stores, such as “Q-Big Store” that may represent a related class of complex POI. In implementations, related descriptors may represent or characterize, for example, a POI offering, a relatively related class of products, services, or any combination thereof. A server, such as a map server, may arrange a data structure of descriptors representing or characterizing POIs of a related class at the same level in the hierarchy (e.g., same number of nodes descending from root). Additionally, POIs of a relatively related class, based on a key word present in a user query, may be rendered using unabridged geometry (e.g., using all available geometric features and/or details). POIs of a relatively unrelated class, based on a key word present in a user query, may be rendered using, for example, abridged geometry (e.g., using fewer than all available geometric features and/or details).

In the example of FIG. 4, if a mobile device user at estimated location 430 submits a query for “shoes,” for example, in addition to organizing a data structure comprising a POI for “shoes” within Q-Mega, a server, such as a map server, may utilize semantic awareness recognition techniques to additionally include a POI for “boots” within Q-Big Store, for example. In another instance, if a mobile device user located at location 430 submits a query for “electronics,” for example, a server, such as a map server, may utilize semantic awareness recognition technique may organize a non-hierarchical data structure comprising the POI for an electronics section of Q-Mega may additionally comprise the POI for a “computers” section of Q-Big Store, for example.

In embodiments, if one or more POIs is identifiable by key words that are semantically distinct from one another, such as “shoes” and “pets,” for example, a POI may be regarded as belonging to unrelated POI classes. Thus, in the example of FIG. 4, responsive to a query comprising a key word “shoes,” a server, such as a map server, may de-emphasize the POI “Q-Pets,” for example by way of rendering Q-Pets on a display using a reduced, lower, or decreased amount of detail and/or a smaller font, etc.

Thus, in embodiments, a server, such as a map server, may organize a data structure based, at least in part, on “semantic” vicinity of a POI to a key word present in a query. For example, in accordance with the FIG. 4, a key word “shoes” may be within a semantic vicinity of one or more POIs that that sell cowboy boots, snow boots, and other specialized outdoor footwear. Consequently, POIs being within a semantic vicinity of a key word may be of a related class based, at least in part, on a semantic vicinity of a POI to a key word. In other instances, POIs being outside of a semantic vicinity of the key word may be of an unrelated class. For example, a POI for “shoes” may be outside of a semantic vicinity of a POI for “pets.” In embodiments, semantic vicinity may be estimated based, at least in part, on a variety of relationships among key words and POIs, and claimed subject matter is not limited in this regard.

FIG. 5 is a partial listing 500 of a first data structure and a second, organized data structure that may be used by a mobile device to generate maps on a display according to an embodiment. In some implementations, a map server, for example, may function to convert first data structure 510 to organized data structure 550 responsive to a user entering a complex POI, such as Q-Mega department store at estimated position 430 of FIG. 4. For example, if a server, such as a map server, receives one or more queries, which may include one or more key words, from a mobile device at estimated position 430, for example, a map server may initiate conversion of first data structure 510 to form organized data structure 550. Organized data structure 550 may then be formatted into one or more messages at a MAC layer, for example, and transmitted to a mobile device at estimated location 430. In other implementations, organized data structure 550 may be generated from first data structure 510 responsive to receipt of a query from a mobile device user at estimated position 430, such as, “map,” for example. It should be noted, however, that a server, such as a map server, may organize data structure 510 to form organized data structure 550 in response to one or more of a large variety of queries and/or location estimates of a mobile device, and claimed subject matter is not limited to particular example queries.

As can be seen in FIG. 5, first data structure 510 may comprise one or more POIs of a shopping mall, for example, be initially organized according to one or more floor descriptor components (e.g., “Level 1” and “Level 2”). Thus, for example, first data structure 510 may comprise first portion 515, which may comprise descriptors for POIs present on a first floor of a shopping mall. Data structure 510 may further comprise second portion 520, which may comprise descriptors for POIs present on a second floor of a shopping mall. Accordingly, for example, responsive to a mobile device user entering the shopping mall, first and second portions 515 and 520 may be transmitted from a server, such as a map server, to the mobile device user. In some instances, in which wireless channel capacity is shared among hundreds, thousands, or a greater number of users, for example, transmission of data structure 510 may consume, for example, several minutes or longer to complete. In many instances, perhaps only after obtaining an entire map file, can a mobile device user make use of indoor navigation techniques to find relevant POIs.

In embodiments, in response to a user-initiated query and/or a mobile device user's estimated location, a server, such as a map server, for example, may organize data structure 510 to form organized data structure 550. A feature of organized data structure 550 may comprise, for example, a hierarchical arrangement of POI descriptors. Hierarchically arranged descriptors of data structure 510 may be organized into a sequence beginning with a root and a first descending node (e.g., Name: Q-Mega) followed by a second descending node (e.g., Name: Q-Big Store), a third descending node, and so on. For example, a mobile device user that has recently entered the Q-Mega department store may receive a portion of a digital map comprising descriptors for POIs in the immediate vicinity of the mobile device user's estimated location. Thus, in one example, responsive to receiving a location estimate from a mobile device a second floor entrance, a server, such as a map server, may transmit POI descriptors beginning with nearby shoe department and electronics department.

In embodiments, a server, such as a map server, may cache previously organized hierarchically arranged data structures for use by mobile device users, for example, who may submit queries comprising similar key words. For example, a map server may cache hierarchically arranged data structures responsive to popular queries submitted by mobile device users entering a complex POI, for example, from a particular entrance. In another example, an organized data structure arranged by a server, such as a map server, responsive to a key word “coffee” from a mobile device user entering a shopping mall may be cached for future mobile device users entering the shopping mall from nearby estimated locations.

In embodiments, a server, such as a map server, may cache a history of hierarchically arranged data structures comprising POI descriptors in response to a number of popular queries, for example. In an implementation, a map server may cache, for example, 25 hierarchically arranged data structures comprising POI descriptors responsive to 25 relatively popular key words. However, it should be noted that claimed subject is intended to embrace caching of any number of hierarchically arranged data structures comprising POI descriptors responsive to any number of queries comprising any number of key words.

In FIG. 5, for example, based on a mobile device user's current estimated location, POI descriptors corresponding to, for example, a shoes and an electronics portion of the Q-Mega department store may be organized to be positioned near an upper portion of data structure 550. Additionally, POIs that may be distant from a mobile device user's estimated location, such as retail outlets Q-Pets, Q-Gadgets, and Q-Toddlers, may be transmitted to a user after transmitting POIs that may be more relevant to a user based on his or her estimated location. However, it should be noted that a variety of arrangements and alternate configurations are possible, and claimed subject matter is not limited in this regard. In the example of FIG. 5, descriptors 565 may correspond to locations within complex POI 560 that may be most relevant to a user located at estimated position 430 of FIG. 4. For example, descriptors 565 may comprise a name descriptor (e.g., Q-Mega), a floor component representing or characterizing estimated location 430 of FIG. 4 (e.g., Q-Mega Level 2), as well as descriptors representing or characterizing particular areas within level 2 of Q-Mega, such as Shoes, Electronics, etc. Descriptor 570, which may pertain to the complex POI Q-Mega, may comprise a floor component representing or characterizing a first floor of the Q-Mega department store, as well as descriptors identifying particular areas located within the first floor, such as Garden, Tools, and so forth. Although not explicitly pointed out in FIG. 5, descriptors identifying particular areas may comprise estimated locations, which may permit a mobile device to render portions of a digital map at appropriate locations on a display.

Descriptors representing or characterizing particular areas may comprise any type of descriptor, such as geometrical descriptions, absolute and/or relative locations, label text, as well as font size, font color, and any other descriptive instructions and claimed subject matter is not limited to use of particular descriptor types. Additionally, although not explicitly identified in FIG. 5, descriptors for less relevant POIs may be de-emphasized in data structure 550 by comprising only abridged geometry (e.g., a reduced, lower, or decreased amount of geometrical detail). Relevant POIs, on the other hand, may be emphasized relative to less relevant POIs by including, for example, unabridged geometry (e.g. an increased, higher, or greater amount of geometrical detail). Further, although only a small number of descriptors are shown in FIG. 5, embodiments may include a large number of descriptors, such as dozens, hundreds, thousands, or a greater number of descriptors identifying complex POIs.

In embodiments, a data structure, such as organized data structure 550, may be transmitted to a mobile device beginning with descriptors 565 representing or characterizing POI 560. Transmission of descriptors 565 may be followed by descriptors 570 and descriptors 585, which may represent or characterize POI 580. Additional descriptors, such as those representing or characterizing POI 590, may follow. Thus, in embodiments, a data structure may be transmitted in a manner that permits receipt of relevant POIs and associated descriptors for immediate display on a display of a user's mobile device.

In implementations, POI descriptors may be streamed to a mobile device, which may be capable of displaying POIs identified using a first portion of a data structure, such as descriptors 565 of FIG. 5, for example. Thus, while receiving subsequent portions of the data structure, such as descriptors 570 and 585, for example, a mobile device may display POIs based, at least in part, on descriptors that have already been received. Accordingly, at least in some implementations, even if a transmission from a server, such as a map server, is interrupted prior to transmitting a complete digital map, or if limited communications channel bandwidth gives rise to significant latencies in a process to transmit, receive, decode, and display a digital map, a mobile device may nonetheless be capable of immediately displaying more relevant portions of a digital map. In embodiments, more relevant portions of the digital map may correspond to POIs in the vicinity of a mobile device user, or may be based, at least in part, on one or more key words transmitted to a server, such as a map server, as part of a user query. It should be noted, however, one or more POIs may be relevant to a mobile device user for other reasons, and claimed subject matter is not limited in this respect.

In embodiments, a mobile device may employ a sequential access parser to parse portions of a hierarchically arranged data structure received from, for example, a map server. In embodiments, a sequential access parser may comprise a Simple Application Program Interface for Extensible Markup Language (SAX) parser, which may have advantages over other parser types such as, for example, a Document Object Model (DOM) parser. In implementations, use of a sequential access parser may enable parsing of received hierarchically arranged data structures of POI descriptors without requiring an entire XML-based descriptor file, for example, to be received prior to initiating a parsing operation.

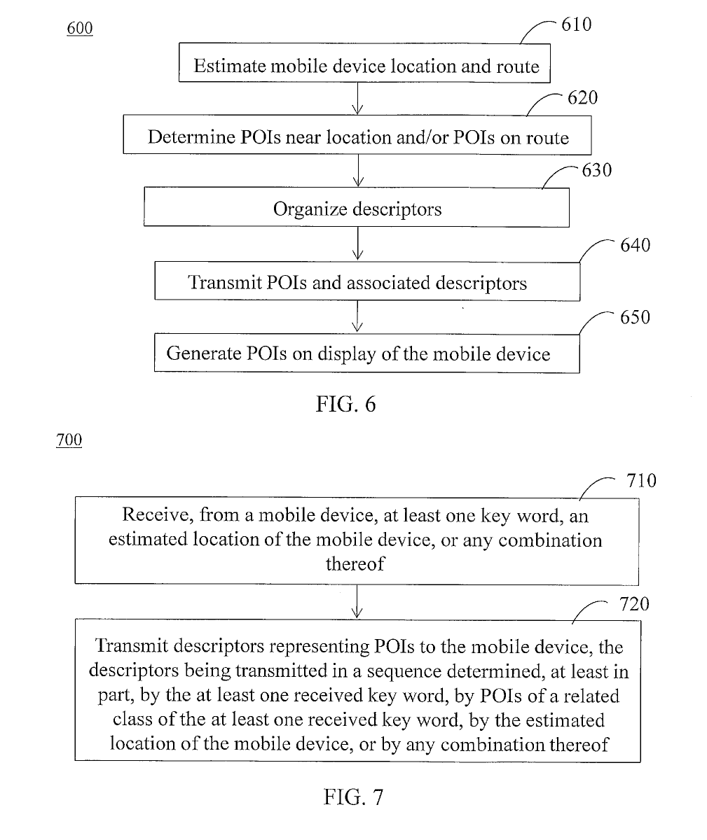

FIG. 6 is a flow diagram of a method 600 for generating maps on a display according to an embodiment. Although the method of FIG. 6, as well as the methods of FIGS. 7, 8, 9, and 10 described herein, may be performed by a mobile device cooperating with a server, such as a map server, for example, in other embodiments, the method of FIG. 6 may be performed by a mobile device operating without cooperation from a map server, for example. Example implementations, such as those described in FIG. 6 and others herein, may include blocks in addition to those shown and described, fewer blocks, blocks occurring in an order different than may be identified, or any combination thereof.

At block 610, a mobile device may compute an estimated location. A mobile device may compute an estimate of its location using any one of the aforementioned techniques. In embodiments, block 610 may also comprise estimating a mobile device user's route as a user travels through a shopping mall, for example. In embodiments, applying a motion model to measurements obtained at a mobile device and/or through the use of inertial sensors may enable a mobile device to de-emphasize POIs that may require a user to backtrack or to deviate from the intended route in order to visit a POI, for example.

At block 620, POIs near a user's estimated location and/or POIs that may be near a user's route may be determined and stored on a server, such as a map server. For example, in FIG. 3, a data structure representing displayed POIs from various locations, such as retail stores within region 220, may be stored in a server, such as a map server, accessible by a mobile device. At block 630, a server, such as a map server, may organize descriptors based on a user-submitted query, a user's estimated location, and/or a user's estimated route. At block 630, POIs and associated descriptors that may be most relevant to a user may appear at a first portion of a data structure at locations that may be transmitted to a mobile device user prior to transmission of less relevant POIs and associated descriptors. At 640, POIs and associated descriptors may be transmitted first, followed by less relevant POIs, and associated descriptors. At 650, POIs may be generated and displayed on a display. In embodiments, more relevant POIs may be emphasized relative to less relevant POIs. Such emphasis may include, but is not limited to, increasing a font size, use of a different font, rendering of geometrical features of less relevant POIs using a reduced, lower, or decreased level of detail and rendering of geometrical features of more relevant POIs with increased, higher, or greater detail, or any combination thereof.

FIG. 7 is a flow diagram of a method 700 for transmitting maps to a mobile device according to an embodiment. At block 710, a map server, for example, may receive at least one key word, perhaps as part of the query submitted from a mobile device, or may receive an estimated location of the mobile device. In embodiments, block 710 may comprise receiving any combination of a key word and/or an estimated location of a mobile device. At block 720, a server, such as a map server, for example, may transmit descriptors representing POIs to the mobile device, wherein the descriptors may be transmitted in a sequence determined, at least in part, by the at least one received key word, by POIs of a related class of the at least one received key word, or by the estimated location of the mobile device, or any combination thereof.

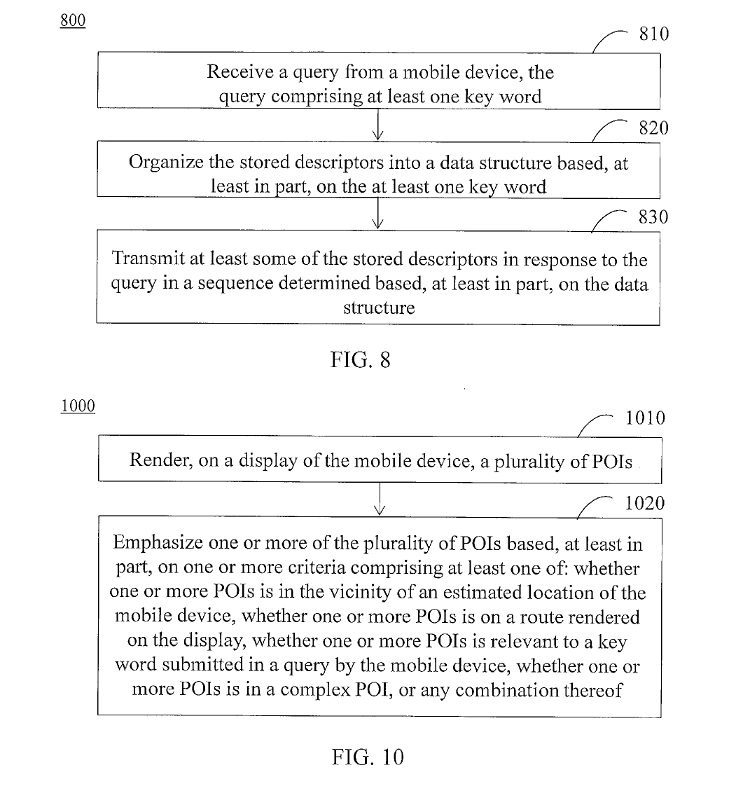

FIG. 8 is a flow diagram of a method 800 for generating maps on a display according to an embodiment. At block 810, a server, such as a map server, for example, may receive a query comprising at least one key word from a mobile device. At 820, a server may organize the stored descriptors into a second data structure based, at least in part, on the at least one key word. At 830, at least some of the stored descriptors may be transmitted from the server (e.g., a map server) in response to the query. The transmission sequence may be determined based, at least in part, on the second data structure.

FIG. 9 is a flow diagram for a method (900) for generating maps on a display according to embodiments. FIG. 9 begins at block 910 in which an estimate of a mobile device user's current location and/or a mobile device user is obtained. Block 920 may comprise a server, such as a map server, detecting one or more POIs in a vicinity of a user's estimated location and/or POIs along a user's route to a POI. Block 930 may comprise retrieving descriptors for POIs, such as those in the vicinity of a user and/or along the user's route, from a map server, for example. Block 940 may comprise rendering details of POIs in the vicinity of the user and/or along a user's route and de-emphasizing less relevant POIs, such as those outside of vicinity of a user, as well as POI not located along a mobile device user's estimated route.

FIG. 10 is a flow diagram for a method (1000) for generating maps on a display according to embodiments. The method of FIG. 10 may begin at block 1010, in which a display of a mobile device may render a plurality of POIs on the display. Block 1020 may comprise emphasizing one or more of the plurality of points of interest based, at least in part, on one or more criteria comprising at least one of: whether one or more POIs is in the vicinity of an estimated location of the mobile device, whether one or more POIs is on a route rendered on the mobile device, whether one or more POIs is relevant to the key word submitted in a query by the mobile device, whether one or more POIs is in a complex POI, or any combination thereof.

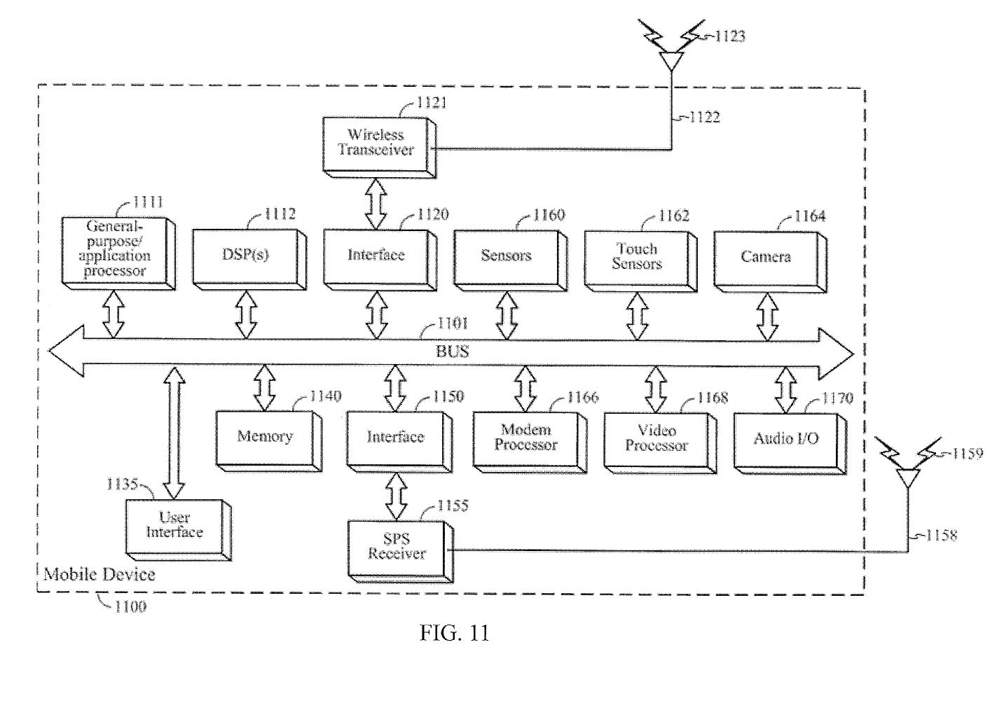

FIG. 11 is a schematic diagram of a mobile device according to an embodiment. Mobile device 102 (FIG. 1) may comprise one or more features of mobile device 1100 shown in FIG. 11. In certain embodiments, mobile device 1100 may also comprise wireless transceiver 1121, which is capable of transmitting and receiving wireless signals 1123 via antenna 1122 over a wireless communication network. Wireless transceiver 1121 may be coupled to bus 1101 by way of wireless transceiver bus interface 1120. Wireless transceiver bus interface 1120 may, in some embodiments be at least partially integrated with wireless transceiver 1121. Some embodiments may include, for example, multiple wireless transceivers 1121 and wireless antennas 1122 to enable transmitting and/or receiving signals according to corresponding multiple wireless communication standards such as, for example, versions of IEEE Std. 802.11, CDMA, WCDMA, LTE, UMTS, GSM, AMPS, Zigbee, and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 11, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 11, a user interface 1135 may comprise any one of several devices such as, for example, a speaker, microphone, display, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general-purpose processor 1111 in response to action from a user. Similarly, applications hosted on mobile device 1100 may store analog or digital signals on memory 1140 to present an output signal to a user. In implementations, a user may interact with user interface 1135 to enter a key word as part of a user initiated query. The query may be transmitted by way of wireless transceiver 1121 to a wireless access point coupled to a server, such as a map server, for example. Responsive to the query, a server, such as a map server, may respond with a hierarchically organized group of descriptors beginning with, for example, descriptors pertaining to POIs that appear to be relevant to one or more key words from the user-initiated query. Relevant POIs may be rendered by video processor 1168 for display on a display. In implementations, POIs may be streamed to a mobile device, which may display relevant POIs using received descriptors while receiving POIs for additional, perhaps less relevant, POIs. In another implementation, mobile device 1100 may optionally include a dedicated audio input/output (I/O) device 1170 comprising, for example, a dedicated speaker, microphone, digital to analog circuitry, analog to digital circuitry, amplifiers, and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression, or manipulation of signals representing captured images. Additionally, video processor 1168 may decode/decompress stored image data for presentation on a display (not shown) of mobile device 1100.

Mobile device 1100 may also comprise sensors 1160 coupled to bus 1101, which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by general purpose application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general-purpose processor or DSP (e.g., general purpose/application processor 1111 or DSP(s) 1112). It should be understood, however, that these are merely examples of structures that may perform baseband processing, and that claimed subject matter is not limited in this respect.

In a particular implementation, mobile device 1000 may be capable of performing one or more of the actions set forth in the process of or more of FIGS. 7, 8, 9, and 10. For example, general-purpose application processor 1111 may perform all or a portion of actions at blocks 710, 720, and/or 730.

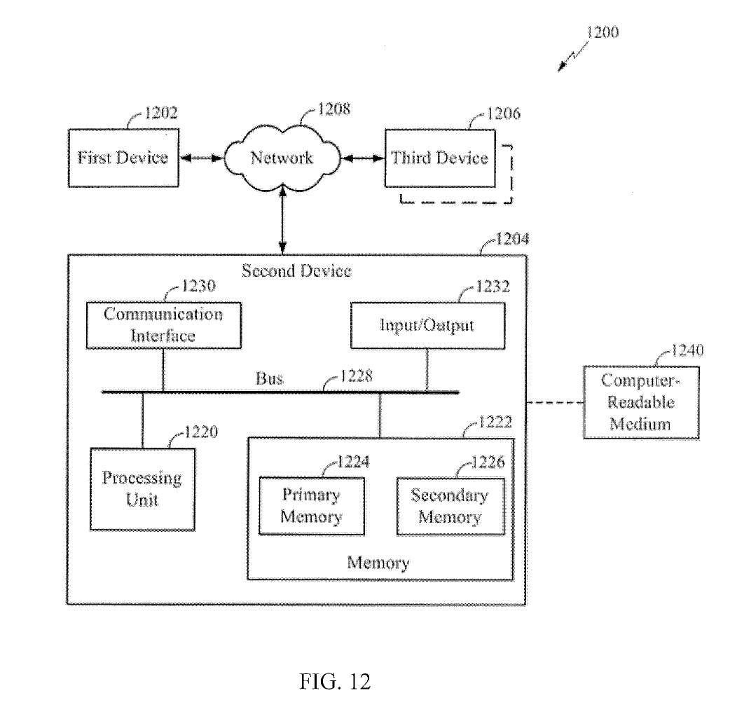

FIG. 12 is a schematic diagram illustrating an example system 1200 that may include one or more devices configurable to implement techniques or processes described above, for example, in connection with FIG. 1. System 1200 may include, for example, a first device 1202, a second device 1204, and a third device 1206, which may be operatively coupled through a wireless communications network 1208. In an aspect, first device 1202 may comprise a server, such as a map server, capable of providing positioning assistance data such as, for example, a base station almanac. Second and third devices 1204 and 1206 may comprise mobile devices, in an aspect. In addition, in an aspect, wireless communications network 1208 may comprise one or more wireless access points, for example. However, claimed subject matter is not limited in scope in these respects.

First device 1202, second device 1204 and third device 1206, as shown in FIG. 10, may be representative of any device, appliance or machine (e.g., such as local transceiver 115 or servers 140, 150 or 155 as shown in FIG. 1) that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, communications network 1208 (e.g., in a particular of implementation of network 130 shown in FIG. 1), may be representative of one or more communication links, processes, or resources configurable to support the exchange of data between at least two of first device 1202, second device 1204, and third device 1206. By way of example but not limitation, communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208. Thus, by way of example but not limitation, second device 1204 may include at least one processing unit 1220 that is operatively coupled to a memory 1222 through a bus 1228. It is recognized that all or part of the various devices and networks shown in system 1200, and the processes and methods as further described herein, may be implemented using or otherwise including hardware, firmware, software, or any combination thereof.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

In particular implementation, second device 1204 may be capable of computing an estimated location of a mobile device. For example, second device 1204 may receive parameters in messages receiving from a client STA, receiving STA and/or sending STA through communication network 1208 for use in forming expressions for use in computing an estimated location of the client STA. In certain implementations, a transceiver (not shown) of a second device 1204 may transmit an estimated location of second device 1204 to first device 1202. Responsive to receiving an estimated location, first device 1202 may organize a data structure so that descriptors for POIs relevant to an estimated location of second device 1204 may be transmitted to the second device. Second device 1204 may immediately display relevant POIs by way of a display (not shown) coupled to, for example bus 1228. In particular implementations, descriptors for POIs may be streamed from a first device 1202 to second device 1204 in a manner that permits depiction of relevant POIs while receiving, for example, descriptors for less relevant POIs. Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1230 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Memory 1222 may represent any suitable or desired information storage medium. For example, memory 1222 may include a primary memory 1224 and a secondary memory 1226. Primary memory 1224 may include, for example, a random access memory, read only memory, etc. While illustrated in this example as being separate from a processing unit, it should be appreciated that all or part of primary memory 1224 may be provided within or otherwise co-located/coupled with processing unit 1220. Secondary memory 1226 may include, for example, the same or similar type of memory as primary memory or one or more information storage devices or systems, such as, for example, a disk drive, an optical disc drive, a tape drive, a solid state memory drive, etc. In certain implementations, secondary memory 1226 may be operatively receptive of, or otherwise enabled to be coupled to, a non-transitory computer-readable medium 1240.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered a self-consistent sequence of operations or similar signal processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or displays of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method comprising:
receiving, from a mobile device, at least one key word, an estimated location of said mobile device, or a combination thereof; and
transmitting descriptors representing points of interest (POIs) to said mobile device, said descriptors being transmitted in a sequence determined, at least in part, by said at least one received key word, by POIs of a related class of said at least one received key word, by said estimated location of said mobile device, or by any combination thereof.

2. The method of claim 1, further comprising:
prior to said transmitting, arranging, into an upper portion of a hierarchical data structure, descriptors representing POIs in a vicinity of said estimated location of said mobile device, or POIs having higher relevance to said at least one received key word; and
prior to said transmitting, arranging, into a lower portion of said hierarchical data structure, descriptors representing POIs outside said vicinity of said estimated location of said mobile device or POIs having lower relevance to said at least one received key word.

3. The method of claim 2, wherein said arranging into said upper portion of said hierarchical data structure comprises arranging descriptors into a first descending node, and wherein said arranging into said lower portion of said hierarchical data structure comprises arranging descriptors into a second descending node.

4. The method of claim 3, wherein transmitting at least some of said descriptors comprises transmitting descriptors arranged in said first descending node of said hierarchical data structure prior to transmitting descriptors arranged in said second descending node of said hierarchical data structure.

5. The method of claim 2, further comprising:
classifying said vicinity of said estimated location of said mobile device as corresponding to a floor of a complex POI comprising a multilevel structure at which said mobile device is estimated to be located.

6. The method of claim 2, wherein said vicinity is based, at least in part, on a semantic vicinity of a POI to said at least one received key word.

7. The method of claim 2, wherein said arranging said descriptors in said hierarchical data structure comprises:
emphasizing said descriptors representing said POIs in said vicinity of said estimated location of said mobile device or POIs having higher relevance to said at least one received key word; and
de-emphasizing descriptors representing POIs outside said vicinity of said estimated location of said mobile device or POIs having lower relevance to said at least one received key word.

8. The method of claim 7, wherein said de-emphasizing said descriptors comprises:
storing, at a first level of geometrical detail, descriptors for POIs outside of said vicinity of said estimated location of said mobile device or POIs having lower relevance to said at least one received key word; and
storing, at a second level of geometrical detail, descriptors for POIs in said vicinity of said estimated location of said mobile device or POIs having higher relevance to said at least one received key word, wherein
said second level of geometrical detail is greater than said first level of geometrical detail.

9. The method of claim 1, further comprising:
determining said POIs of said related class of said at least one received key word based, at least in part, on relevance of a product, a service, or any combination thereof, with respect to said at least one received key word.

10. The method of claim 1, further comprising:
storing descriptors, representing POIs of said related class of said at least one received key word, using a higher level of detail compared to descriptors representing POIs outside of said related class of said at least one received key word.

11. A server comprising:
a transceiver to access a wireless communications channel; and
one or more processors coupled to said transceiver to:
obtain, from a message received at said transceiver, from a mobile device, at least one key word, an estimated location of said mobile device, or a combination thereof; and
initiate transmission of descriptors, through said transceiver, said descriptors representing points of interest (POIs) to said mobile device, said descriptors being transmitted in a sequence determined, at least in part, by said at least one key word, by POIs of a related class of said at least one key word, by said estimated location of said mobile device, or by any combination thereof.

12. The server of claim 11, wherein said one or more processors are additionally to:
arrange, into an upper portion of a hierarchical data structure, descriptors that represent POIs in a vicinity of said estimated location of said mobile device or that represent POIs having greater relevance to said at least one key word; and
arrange, into a lower portion of said hierarchical data structure, descriptors that represent POIs outside of said vicinity of said estimated location of said mobile device or that have lower relevance to said at least one key word.

13. The server of claim 12, wherein said one or more processors are additionally to:
classify said vicinity of said estimated location of said mobile device as corresponding to a floor of a complex POI comprising a multilevel structure at which said mobile device is estimated to be located.

14. The server of claim 12, wherein said one or more processors are additionally to:
emphasize said descriptors representing POIs in said vicinity of said mobile device or POIs having higher relevance to said at least one key word; and
de-emphasize descriptors representing POIs outside said vicinity of said estimated location of said mobile device or POIs having lower relevance to said at least one key word.

15. The server of claim 14, wherein said one or more processors are additionally to:
arrange, at a first level of geometrical detail, descriptors for POIs outside of said vicinity of said estimated location of said mobile device or POIs having lower relevance to said at least one key word; and
arrange, at a second level of geometrical detail, descriptors for POIs in said vicinity of said estimated location of said mobile device or POIs having higher relevance to said at least one key word, wherein
said second level of geometrical detail is greater than said first level of geometrical detail.

16. The server of claim 12, wherein said one or more processors are additionally to:
initiate transmission of descriptors arranged by said server in a first descending node of said hierarchical data structure prior to transmitting descriptors arranged in a second descending node of said hierarchical data structure.

17. The server of claim 11, wherein said one or more processors are additionally to:
determine said POIs of said related class of said at least one key word based, at least in part, on relevance of a product, a service, or any combination thereof, with respect to said at least one key word.

18. The server of claim 11, wherein said one or more processors are additionally to:
arrange descriptors, representing POIs of said related class of said at least one key word, using a higher level of detail compared to descriptors representing POIs outside of said related class as said at least one key word.

19. The server of claim 11, wherein said one or more processors are additionally to:
determine semantic vicinity of one or more POIs to said at least one key word;
emphasize said descriptors representing POIs within said semantic vicinity to said at least one key word; and
de-emphasize descriptors representing POIs outside said semantic vicinity to said at least one key word.

20. An article comprising:
a storage medium comprising machine-readable instructions stored thereon which are executable by one or more processors of a server to:
obtain, from a message received at a transceiver, from a mobile device, at least one key word, an estimated location of said mobile device, or a combination thereof; and
initiate transmission of descriptors, through the transceiver, representing points of interest (POIs) to said mobile device, said descriptors being transmitted in a sequence determined, at least in part, by said at least one key word, by POIs of a related class of said at least one key word, by said estimated location of said mobile device, or by any combination thereof.

21. The article of claim 20, wherein said storage medium comprising machine-readable instructions stored thereon which are executable by said one or more processors of said server are additionally to:
arrange into an upper portion of a hierarchical data structure, prior to said initiating transmission, descriptors representing POIs in a vicinity of said estimated location of said mobile device POIs having higher relevance to said at least one key word; and
arrange into a lower portion of said hierarchical data structure, prior to said transmitting, descriptors representing POIs outside said vicinity of said estimated location of said mobile device or POIs having lower relevance to said at least one key word.

22. The article of claim 21, wherein said storage medium further comprises machine-readable instructions stored thereon which are executable by said one or more processors of said server to:
emphasize said descriptors representing POIs in said vicinity of said mobile device or POIs having higher relevance to said at least one key word; and
de-emphasize descriptors representing POIs outside said vicinity of said estimated location of said mobile device or POIs having lower relevance to said at least one key word.

23. The article of claim 22, wherein said storage medium further comprises machine-readable instructions stored thereon which are executable by said one or more processors of said server to:
arrange, at a first level of geometrical detail, descriptors for POIs outside of said vicinity of said estimated location or POIs having lower relevance to said at least one key word; and
arrange, at a second level of geometrical detail, descriptors for POIs in said vicinity of said estimated location of said mobile device or POIs having higher relevance to said at least one key word, wherein said second level of geometrical detail is greater than said first level of geometrical detail.

24. The article of claim 20, wherein said storage medium further comprises machine-readable instructions stored thereon which are executable by said one or more processors of said server to:
arrange descriptors, representing POIs of said related class of said at least one key word, using a higher level of detail compared to descriptors representing POIs outside of said related class as said at least one key word.

25. An apparatus comprising:
means for obtaining, from a message received at a transceiver from a mobile device, at least one key word, an estimated location of said mobile device, or a combination thereof; and
means for transmitting descriptors, through the transceiver, representing points of interest (POIs) to said mobile device, said descriptors transmitted in a sequence determined, at least in part, by said at least one received key word, by POIs of a related class of said at least one received key word, by said estimated location of said mobile device, or by any combination thereof.

26. The apparatus of claim 25, further comprising:
means for arranging, into an upper portion of a hierarchical data structure, descriptors representing POIs in a vicinity of said estimated location of said mobile device, or POIs having higher relevance to said at least one key word; and
means for arranging, into a lower portion of said hierarchical data structure, descriptors representing POIs outside said vicinity of said estimated location of said mobile device, or POIs having lower relevance to said at least one received key word.

27. The apparatus of claim 26, further comprising:
means for classifying said vicinity of said estimated location of said mobile device as corresponding to a floor of a complex POI comprising a multilevel structure at which said mobile device is estimated to be located.

28. The apparatus of claim 25, further comprising:
means for storing descriptors, representing POIs of said related class of said at least one received key word, using a higher level of detail compared to descriptors representing POIs outside of said related class as said at least one received key word.

29. A method comprising, at a mobile device:
rendering, on a display of said mobile device, a plurality of points of interest (POIs); and
emphasizing one or more of said plurality of POIs based, at least in part, on one or more criteria comprising at least one of: whether one or more POIs is in a vicinity of an estimated location of said mobile device, whether one or more POIs is on a route rendered on said display, whether one or more POIs is relevant to a key word submitted in a query by said mobile device, whether one or more POIs is in a complex POI, or any combination thereof.

30. The method of claim 29, wherein said emphasizing is in relation to POIs of said plurality of POIs located outside said vicinity, aside said rendered route, unrelated to said key word, or outside said complex POI.

31. The method of claim 29, wherein whether said one or more of said plurality of POIs is relevant to said key word is determined based, at least in part, on relevance of a product, a service, or any combination thereof.

32. The method of claim 29, wherein whether said one or more of said plurality of POIs is relevant to said key word is determined based, at least in part, on whether said one or more of said plurality of POIs is relevant to a related class with respect to said key word.

33. The method of claim 29, wherein said vicinity is based, at least in part, on whether said mobile device and said one or more of said plurality of POIs are on the same floor of a complex POI comprising a multilevel structure.

34. The method of claim 29, wherein said vicinity is based, at least in part, on whether a semantic vicinity exists among of said one or more of said plurality of POIs to said key word.

35. The method of claim 29, wherein said emphasizing further comprises:
rendering, at a first level of detail, said one or more POIs in said vicinity of said estimated location of said mobile device, said one or more POIs on said route rendered on said display, said one or more POIs relevant to said key word submitted in said query by said mobile device, said one or more POIs being in a complex POI, or on any combination thereof; and
rendering, at a second level of detail, POIs outside of said vicinity of said estimated location of said mobile device or aside of said rendered route.

36. The method of claim 35, wherein said first level of detail corresponds to a greater level of detail than said second level of detail.

37. The method of claim 29, wherein emphasizing said one or more of said plurality of POIs comprises:
rendering a first POI of said one or more POIs with a larger font size than that of a rendering of a second POI of said one or more POIs.

38. A mobile device, comprising:
a display to render a plurality of points of interest (POIs); and
one or more processors coupled to said display to:
emphasize one or more of said plurality of POIs based, at least in part, on one or more criteria comprising at least one of: whether one or more POIs is in a vicinity of an estimated location of said mobile device, whether one or more POIs is on a route rendered on said display, whether one or more POIs is relevant to a key word submitted in a query by said mobile device, whether one or more POIs is in a complex POI, or on any combination thereof.

39. The mobile device of claim 38, wherein said emphasizing of said one or more of said plurality of POIs is in relation to POIs of said plurality of POIs being located outside said vicinity, aside said rendered route, unrelated to said key word, or outside of said complex POI.

40. The mobile device of claim 38, wherein said one or more processors are additionally to:
initiate rendering of one or more emphasized POIs based, at least in part, on whether said one or more of said plurality of POIs is relevant to a product, a service, or any combination thereof, with respect to said key word.

41. The mobile device of claim 38, wherein said one or more processors are additionally to:
initiate rendering of one or more relevant POIs based, at least in part, on whether said one or more of said plurality of POIs is relevant to a related class of said key word.

42. The mobile device of claim 38, wherein said one or more processors are additionally to:
initiate rendering of one or more POIs in said vicinity based, at least in part, on whether said mobile device and said one or more POIs are on the same floor of a complex POI comprising a multilevel structure.

43. The mobile device of claim 38, wherein said one or more processors are additionally to:
initiate rendering of one or more POIs in said vicinity based, at least in part, on whether semantic vicinity exists among one or more POIs and said key word.

44. The mobile device of claim 38, wherein said one or more processors are additionally to:
initiate rendering, at a first level of detail, of said one or more POIs in said vicinity of said estimated location of said mobile device, said one or more POIs on said route rendered on said mobile device, said one or more POIs relevant to said key word submitted in said query by said mobile device, said one or more POIs being in a complex POI, or on any combination thereof; and
initiate rendering, at a second level of detail, POIs outside of said vicinity of said estimated location of said mobile device or aside of said rendered route.

45. The mobile device of claim 44, wherein said first level of detail corresponds to a greater level of detail than said second level of detail.

46. The mobile device of claim 38, wherein said one or more processors are additionally to:
initiate rendering of a first of said one or more POIs using a font size larger than that of a rendering of a second of said one or more POIs.

47. The mobile device of claim 38, wherein said one or more processors are additionally to:
initiate rendering of a first of said one or more POIs using higher level of brightness relative to a second of said one or more POIs.

48. The mobile device of claim 38, wherein said one or more processors are additionally to:
initiate operation of a sequential access parser, at said mobile device, for processing an XML data structure transmitted from a server.

49. The mobile device of claim 48, wherein said sequential access parser at said mobile device corresponds to a SAX parser.

50. An article comprising:
a storage medium comprising machine-readable instructions stored thereon which are executable by one or more processors of a mobile device to:
emphasize one or more of a plurality of POIs based, at least in part, on one or more criteria comprising at least one of: whether one or more POIs is in a vicinity of an estimated location of said mobile device, whether one or more POIs is on a route rendered on a display, whether one or more POIs is relevant to a key word submitted in a query by said mobile device, whether one or more POIs is in a complex POI, or on any combination thereof.

51. The article of claim 50, wherein said storage medium further comprises machine-readable instructions stored thereon which are executable by said one or more processors of said mobile device to:
initiate rendering of one or more emphasized POIs based, at least in part, on whether said one or more of said plurality of POIs is relevant to a product, a service, or any combination thereof, with respect to said key word.

52. The article of claim 50, wherein said storage medium further comprises machine-readable instructions stored thereon which are executable by said one or more processors of said mobile device to:
render one or more POIs being in said vicinity based, at least in part, on whether said mobile device and said one or more rendered POIs are on the same floor of a complex POI comprising a multilevel structure.

53. A mobile device, comprising:
means for rendering a plurality of points of interest (POIs); and
means for emphasizing one or more of said plurality of POIs based, at least in part, on one or more criteria comprising at least one of: whether one or more POIs is in a vicinity of an estimated location of said mobile device, whether one or more POIs is on a route rendered on said mobile device, whether one or more POIs is relevant to a key word submitted in a query by said mobile device, whether one or more POIs is in a complex POI, or on any combination thereof.

54. The mobile device of claim 53, wherein said means for emphasizing said one or more of said plurality of POIs is in relation to POIs being located outside said vicinity, aside said rendered route, unrelated to said key word, or outside said complex POI.

55. The mobile device of claim 53, further comprising:
means for rendering a first of said one or more POIs using higher brightness relative to a second of said one or more POIs.
